(19) United States
(12) Patent Application Publication
(10) Pub. No.: US 2026/0365411 A1
(43) Pub. Date: Nov. 19, 2026

(54) THREADED FLOWERPOT WITH THREADED DRIP PAN OR LID

(71) Applicant: Brian A. Robinson, JR., McCordsville, IN (US)

(72) Inventor: Brian A. Robinson, JR., McCordsville, IN (US)

(21) Appl. No.: 19/207,486

(22) Filed: May 14, 2025

(51) Int. Cl. B65D 81/36; A01G 9/02; B65D 43/02

(52) U.S. Cl. CPC B65D 81/365; A01G 9/02; B65D 43/0231; B65D 2543/00092; B65D 2543/00527; B65D 2543/00537

(57) ABSTRACT

A convertible flowerpot may include a flowerpot body having an open top and a bottom portion, wherein the bottom portion includes first threading and the open top includes second threading; and a drip pan including a sidewall and a base, the sidewall including complementary threading configured to selectively engage with either the first threading or the second threading of the flowerpot body, wherein the drip pan is threadably attachable to the bottom portion of the flowerpot body in a first configuration to collect excess water during plant cultivation, and threadably attachable to the open top of the flowerpot body in a second configuration to enclose the flowerpot body as a storage container.

### TECHNICAL FIELD

The embodiments generally relate to containers for plant cultivation, and more particularly to threaded flowerpots with threaded drip pans.

### BACKGROUND

Conventional flowerpots are commonly used for displaying and cultivating plants in both indoor and outdoor environments. These containers are typically constructed from materials such as ceramic, plastic, or clay and include an open top for receiving soil and a base with one or more drainage holes to allow excess water to escape. To prevent damage to surfaces from water runoff, users often place separate saucers or trays beneath the flowerpots to catch draining water.

Many flowerpot systems include a non-integrated drip tray or saucer designed to rest beneath the pot. These accessories function by collecting overflow water after irrigation and are often sold separately from the flowerpot itself. While these components serve a protective function, they generally require manual alignment, occupy additional space, and may shift or spill when the flowerpot is moved. In some cases, water trapped in the tray may become stagnant or require frequent cleaning to avoid buildup.

Traditional flowerpots are usually designed for a singular purpose: supporting plant growth. While some decorative containers may double as storage vessels when not in use, they typically lack structural or functional features that enable easy conversion between distinct uses. Additionally, conventional flowerpots and trays are not usually constructed with modularity or reconfiguration in mind, which can limit their adaptability in compact or multifunctional living spaces.

### SUMMARY

This summary is provided to introduce a variety of concepts in a simplified form that is further disclosed in the detailed description of the embodiments. This summary is not intended to identify key or essential inventive concepts of the claimed subject matter, nor is it intended to determine the scope of the claimed subject matter.

A convertible flowerpot assembly integrates a threaded flowerpot body and a threaded drip pan to enable dual functionality for plant cultivation and general-purpose storage. The assembly features a flowerpot with threading on both its bottom portion and its open top, along with a drip pan having complementary threading. This configuration allows the drip pan to be selectively attached either below the flowerpot to catch excess water or above the flowerpot to function as a lid.

In one configuration, the drip pan threads onto the bottom of the flowerpot to operate as a water-catching base, providing a secure and space-efficient solution for managing irrigation runoff. This eliminates the need for separate trays or saucers, reducing the number of components while preventing unwanted movement or spills during plant care.

In a second configuration, the same drip pan may be threaded onto the open top of the flowerpot to form a sealed container for storage purposes. This dual-use capability enhances the functionality of the flowerpot by allowing the user to transition between cultivation and storage configurations without tools or additional hardware.

The components of the assembly may be manufactured from various materials, including plastic, ceramic, metal, or rubber, and may include decorative or textured surfaces. The threading is designed to ensure secure engagement and watertight integrity in both operational configurations.

By integrating interchangeable functionality through a threaded interface, the disclosed flowerpot assembly offers a compact, user-friendly solution that addresses space limitations, supports aesthetic preferences, and eliminates the reliance on multiple discrete components commonly used in conventional plant care and storage systems.

Other illustrative variations within the scope of the invention will become apparent from the detailed description provided hereinafter. The detailed description and enumerated variations, while disclosing optional variations, are intended for purposes of illustration only and are not intended to limit the scope of the invention.

### BRIEF DESCRIPTION OF THE DRAWINGS

A more complete understanding of the embodiments, and the attendant advantages and features thereof, will be more readily understood by references to the following detailed description when considered in conjunction with the accompanying drawings wherein:

FIGS. 1-3 depict variations of the disclosed threaded flowerpot with threaded drip pan or lid, according to some embodiments; and

FIGS. 4-6 depict variations of a drip pan or lid to be threadingly attached to a threaded flowerpot, according to some embodiments.

### DETAILED DESCRIPTION

The specific details of the single embodiment or variety of embodiments described herein are set forth in this application. Any specific details of the embodiments described herein are used for demonstration purposes only, and no unnecessary limitation(s) or inference(s) are to be understood or imputed therefrom.

Before describing exemplary embodiments in detail, it is noted that the embodiments reside primarily in combinations of components related to devices and systems. Accordingly, the device components have been represented where appropriate by conventional symbols in the drawings, showing only those specific details that are pertinent to understanding the embodiments of the present disclosure so as not to obscure the disclosure with details that will be readily apparent to those of ordinary skill in the art having the benefit of the description herein.

A convertible flowerpot assembly may include a flowerpot body and a detachable drip pan. The flowerpot body may be generally cylindrical, conical, or frustoconical in shape and defines an internal cavity suitable for receiving soil, a plant, or other contents. The flowerpot body may have an open top and a bottom portion, each configured with external threading. The bottom portion may include a first threading, and the open top may include a second threading. These threads may be integrally molded or machined into the body during manufacture and may share a common diameter and pitch or vary depending on the intended attachment function.

The drip pan may be a shallow, circular container having a sidewall and a base. The interior surface of the sidewall may include threading complementary to the first and second threading of the flowerpot body. The base of the drip pan may be concave to assist with retaining water and preventing overflow. The drip pan may be attachable to either the bottom portion or the open top of the flowerpot body by rotating the pan to engage the threading, forming a releasable and secure connection in either configuration.

In one configuration, the user may thread the drip pan to the bottom of the flowerpot body. In this mode, the assembly functions as a traditional flowerpot for plant cultivation. Water added during irrigation may pass through perforations formed in the base of the flowerpot and collect in the interior reservoir of the drip pan. This prevents water from leaking onto surfaces and allows the user to monitor or remove excess water as needed. The threads in this configuration may include seals, gaskets, or precision mating surfaces to minimize leakage.

In a second configuration, the drip pan may be removed from the bottom portion and attached to the open top of the flowerpot body. When secured to the second threading, the drip pan functions as a lid, converting the assembly into an enclosed storage container. This may be used to store items such as gardening tools, household objects, or non-plant materials. In this configuration, the base of the drip pan may engage the top rim of the flowerpot body to form a substantially watertight enclosure. An annular lip on the pan may assist with gripping and attachment.

Each component of the flowerpot assembly may be fabricated from materials including plastic, ceramic, metal, rubber, or a combination thereof. The flowerpot body and the drip pan may be made of different materials depending on desired aesthetics, performance, or cost. In some variations, the body may include decorative external surfaces, such as embossed textures, painted finishes, or molded patterns to enhance visual appeal.

The threading between the flowerpot body and the drip pan may be configured to provide a standardized thread profile. For example, a common thread pitch and diameter may be used across a product line to ensure that different flowerpot assemblies and drip pans may be interchanged or combined modularly. The threading may be manufactured by injection molding, casting, machining, or other conventional fabrication techniques. Threaded segments may also be reinforced to accommodate repeated engagement and disengagement.

In some variations, the system may include a second drip pan attachable to the end opposite the one engaged by a first drip pan. For instance, a user may install a drip pan on the bottom to catch water while simultaneously threading a second drip pan onto the top to form a lid, creating a dual-containment setup. Each pan may be formed with threading that is compatible with either end of the flowerpot body.

A modular flowerpot system may include two or more flowerpot bodies configured to stack vertically by threading one body onto another. For example, a second flowerpot body may have a bottom portion with third threading configured to engage with the second threading of a first flowerpot body. This allows the second flowerpot to be screwed directly onto the open top of the first flowerpot. The dimensions of the bottom of the second flowerpot and the open top of the first may be aligned to provide stable vertical orientation and prevent lateral movement.

In some embodiments, a sealing ring or gasket may be placed between stacked flowerpot bodies to improve fluid sealing and structural stability. The stacked configuration may be used for vertical gardening or for conserving surface area in compact environments. A plurality of flowerpot bodies may be sequentially connected using similar threading to form a tower or column. When used for cultivating plants, the perforated bases of the upper flowerpots may allow water to flow downward into the lower bodies, ultimately collecting in a drip pan attached to the lowermost unit.

The components may be disassembled for cleaning, rearrangement, or storage. The flowerpot bodies and drip pans may be offered in various colors, textures, or finishes and scaled to different sizes to accommodate a range of plant species or storage capacities. In some cases, decorative sleeves may be placed around the flowerpot body without interfering with the threading interface, offering additional personalization options.

The described assembly may be used in both indoor and outdoor environments. During use, a user may insert soil and a plant into the flowerpot cavity, attach the drip pan to the bottom to collect water, and later remove and reattach the pan to the top for sealed storage. The components may be cleaned and reused repeatedly, and all operations may be performed by hand without the need for tools.

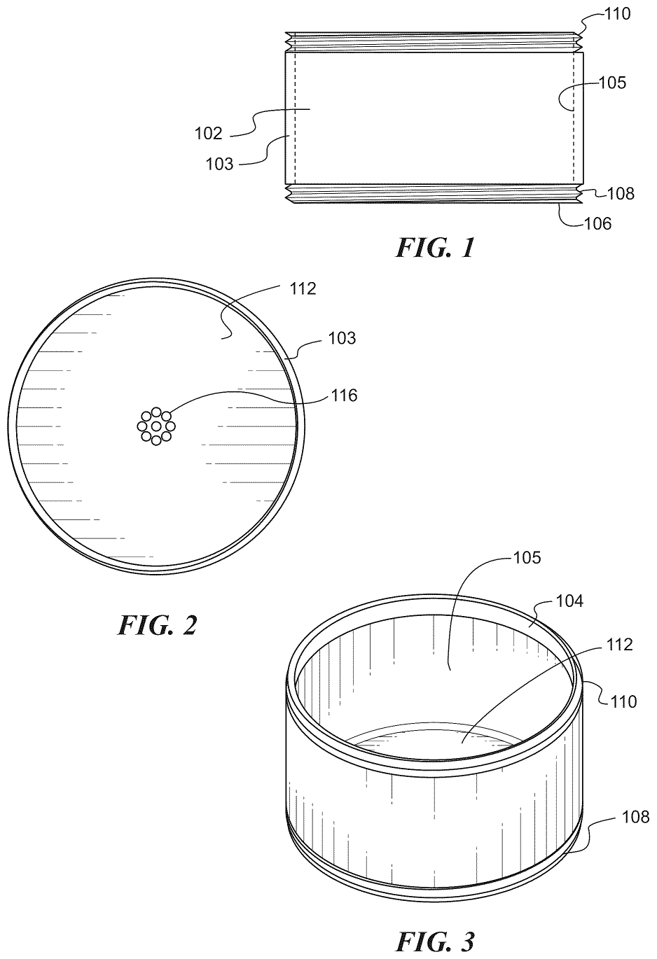

FIGS. 1-3 depict variations of the disclosed threaded flowerpot with threaded drip pan or lid including a flowerpot body 102 having an open top 104 and a bottom portion 106, wherein the bottom portion 106 includes first threading 108 and the open top 104 includes second threading 110. The body 102 may be generally cylindrical in shape. The flowerpot may include a first sidewall 103 and bottom plate 112 as part of the body 102, wherein the body 102 defines a first cavity 105 therein. In embodiments, the bottom plate 112 defines one or more perforations 116 to allow drainage from the first cavity 105.

FIG. 1 illustrates a perspective view of a flowerpot body 102 having an open top 104 and a bottom portion 106. The flowerpot body 102 is shown in a generally cylindrical form and includes a first sidewall 103 that defines a first cavity 105. The open top 104 is configured to receive soil or other planting media, and the bottom portion 106 supports the flowerpot during use. First threading 108 is shown extending circumferentially around the outer surface of the bottom portion 106, while second threading 110 is shown near the top rim of the flowerpot body 102.

FIG. 2 provides a side elevation view of the flowerpot body 102. The first threading 108 and second threading 110 are both visible, indicating the dual-thread configuration that enables the flowerpot body to receive a drip pan on either end. The first sidewall 103 extends continuously between the open top 104 and the bottom portion 106, forming the structure of the cavity 105.

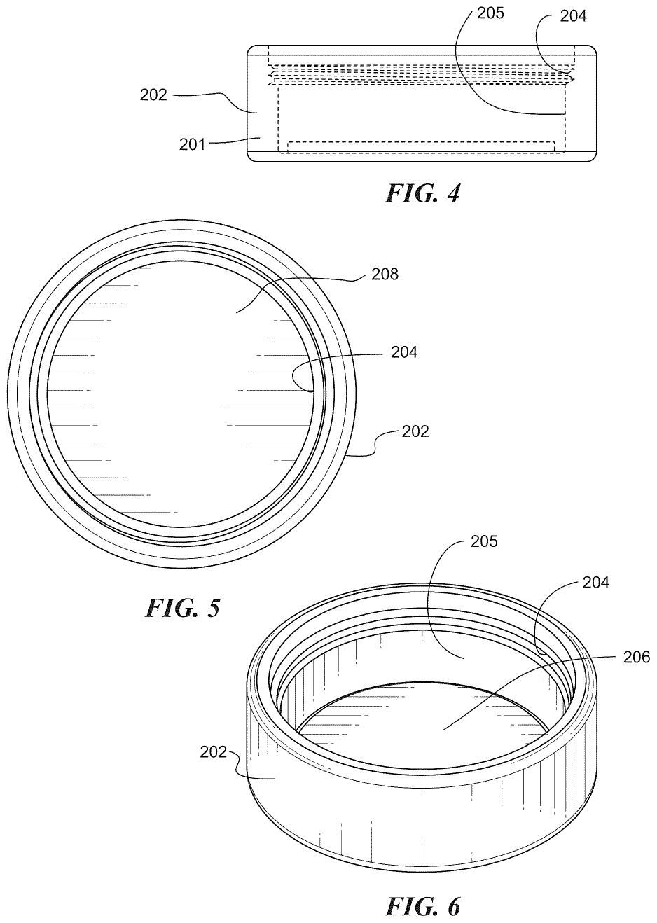

FIG. 3 is a cross-sectional view of the flowerpot body 102 taken along a vertical plane. The internal first cavity 105 is clearly shown, bounded by the first sidewall 103 and a bottom plate 112. The bottom plate 112 may be integrally formed with or affixed to the sidewall 103 and includes one or more perforations 116 to allow for water drainage. The first threading 108 is formed on the exterior of the bottom portion 106, and the second threading 110 is formed on the exterior of the open top 104. These threads are configured to threadably engage with the drip pan of FIG. 4.

FIGS. 4-6 depict variations of a drip pan 202 or lid including a second sidewall 201 and a base 206, wherein the drip pan 202 defines a second cavity 205 therein, the second sidewall 201 including complementary threading 204 configured to selectively engage with either the first threading 108 or the second threading 110 of the flowerpot body 102 depicted in FIGS. 1-3, wherein the drip pan 202 is threadably attachable to the bottom portion 106 of the flowerpot body 102 in a first configuration to collect excess water during plant cultivation, and threadably attachable to the open top 104 of the flowerpot body 102 in a second configuration to enclose the flowerpot body 102 as a storage container. In some embodiments, multiple drip pans 202 may be attachable to the flowerpot body 102 via the first threading 108 or the second threading 110 of the flowerpot body 102.

FIG. 4 illustrates a perspective view of a drip pan 202, which may function either as a water-catching base or a lid. The drip pan 202 includes a second sidewall 201 and a base 206. Internal or complementary threading 204 is visible on the inner circumference of the second sidewall 201 and is configured to engage either the first threading 108 or the second threading 110 of the flowerpot body 102. The base 206 may be concave or flat and is configured to retain water or enclose the open top of the flowerpot body.

FIG. 5 is a cross-sectional view of the drip pan 202. The second cavity 205 is formed between the second sidewall 201 and the base 206. The internal threading 204 is visible along the upper region of the sidewall 201 and may extend partially or fully along the interior circumference. In some embodiments, the base 206 may include a downward-facing surface and a peripheral lip or flange 208 to assist with manual gripping. The second cavity 205 is dimensioned to receive water drained from the flowerpot or to enclose contents within the flowerpot body when used as a lid.

FIG. 6 depicts an exploded assembly view of the convertible flowerpot system. The flowerpot body 102 is aligned with the drip pan 202, illustrating the possibility of attaching the drip pan 202 either to the bottom portion 106 via the first threading 108 or to the open top 104 via the second threading 110. This configuration demonstrates the reversible attachment of the drip pan, enabling the system to operate in either a plant cultivation mode (with the drip pan serving as a water tray) or a storage mode (with the drip pan serving as a lid).

In this disclosure, the descriptions of the various embodiments have been presented for purposes of illustration and are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein. Thus, the appended claims should be construed broadly, to include other variants and embodiments, which may be made by those skilled in the art.

It will be appreciated by persons skilled in the art that the present embodiment is not limited to what has been particularly shown and described hereinabove. A variety of modifications and variations are possible considering the above teachings without departing from the following claims.

I/we claim:

1. A convertible flowerpot assembly comprising:
a flowerpot body having an open top and a bottom portion, wherein the bottom portion includes first threading and the open top includes second threading; and
a drip pan comprising a sidewall and a base, the sidewall including complementary threading configured to selectively engage with either the first threading or the second threading of the flowerpot body, wherein the drip pan is threadably attachable to the bottom portion of the flowerpot body in a first configuration to collect excess water during plant cultivation, and threadably attachable to the open top of the flowerpot body in a second configuration to enclose the flowerpot body as a storage container.

2. The convertible flowerpot assembly of claim 1, wherein the flowerpot body and the drip pan are each made from a material selected from the group consisting of plastic, ceramic, metal, and rubber.

3. The convertible flowerpot assembly of claim 1, wherein the drip pan includes an interior reservoir region for temporarily holding water, thereby preventing overflow onto surrounding surfaces during plant irrigation.

4. The convertible flowerpot assembly of claim 1, wherein the threading of the flowerpot body and the drip pan is configured to provide a watertight seal in both the first and second configurations.

5. The convertible flowerpot assembly of claim 1, wherein the flowerpot body further comprises external decorative features selected from the group consisting of embossed patterns, painted finishes, and textured surfaces.

6. The convertible flowerpot assembly of claim 1, wherein the flowerpot body comprises a plurality of perforations in the bottom portion to allow fluid to drain from the interior of the flowerpot into the drip pan when attached in the first configuration.

7. The convertible flowerpot assembly of claim 1, wherein the drip pan includes an annular lip extending outward from the sidewall to facilitate manual attachment and detachment by a user.

8. The convertible flowerpot assembly of claim 1, wherein the complementary threading of the drip pan is formed integrally with the sidewall during molding or fabrication.

9. The convertible flowerpot assembly of claim 1, wherein the threading between the drip pan and the flowerpot body comprises a standardized pitch and diameter to support interchangeability among a plurality of flowerpot assemblies.

10. The convertible flowerpot assembly of claim 1, wherein the flowerpot body and the drip pan are made from different materials selected from the group consisting of ceramic, plastic, metal, and rubber.

11. The convertible flowerpot assembly of claim 1, wherein the base of the drip pan is concave to retain liquid and prevent spillage during transportation or movement.

12. The convertible flowerpot assembly of claim 1, wherein the flowerpot body includes decorative surface features selected from the group consisting of textures, embossed patterns, and painted finishes.

13. The convertible flowerpot assembly of claim 1, wherein the drip pan, when attached to the open top of the flowerpot body, is configured to form a substantially watertight enclosure.

14. The convertible flowerpot assembly of claim 1, wherein a second drip pan is attachable to the remaining threading when the first drip pan is engaged, thereby allowing dual containment configurations.

15. A modular flowerpot system comprising:
a first flowerpot body having an open top and a bottom portion, the bottom portion comprising first threading and the open top comprising second threading;
a second flowerpot body having a bottom portion comprising third threading complementary to the second threading of the first flowerpot body; and
a drip pan comprising a sidewall and a base, the sidewall including internal threading configured to selectively engage with either the first threading or the second threading of the first flowerpot body, wherein the second flowerpot body is stackably attachable to the first flowerpot body by threadably engaging the third threading with the second threading, and wherein the drip pan is selectively attachable to either flowerpot body to collect excess water or form a lid.

16. The system of claim 15, wherein the flowerpot bodies are dimensioned such that the open top of the first flowerpot body aligns with the base profile of the second flowerpot body to provide vertical alignment during stacking.

17. The system of claim 15, further comprising a sealing ring disposed between the second threading of the first flowerpot body and the third threading of the second flowerpot body to reduce leakage between stacked units.

18. The system of claim 15, wherein a plurality of flowerpot bodies are sequentially stackable in a vertical arrangement through threaded connections.

19. The system of claim 15, wherein the drip pan is attachable to the lowermost flowerpot body to collect irrigation runoff from all stacked flowerpot bodies.

20. The system of claim 15, wherein each flowerpot body defines a central cavity with one or more perforations in the base to allow water flow through vertically aligned cavities in a stacked configuration.
